(19) United States
(12) Patent Application Publication
(10) Pub. No.: US 2017/0054955 A1
(43) Pub. Date: Feb. 23, 2017

(54) LIQUID CRYSTAL DEVICE AND PROJECTOR

(71) Applicant: SEIKO EPSON CORPORATION, Tokyo (JP)

(72) Inventor: Hiroko SAWAI, Shiojiri-shi (JP)

(73) Assignee: SEIKO EPSON CORPORATION, Tokyo (JP)

(21) Appl. No.: 15/204,373

(22) Filed: Jul. 7, 2016

(30) Foreign Application Priority Data
Aug. 19, 2015 (JP) 2015-161671

(51) Int. Cl. H04N 9/31

(52) U.S. Cl. CPC H04N 9/3105; H04N 9/312

(57) ABSTRACT

A projector includes a liquid crystal device for a blue color including a liquid crystal material for a blue color, a liquid crystal device for a green color, and a liquid crystal device for a red color, and in a liquid crystal material for a blue color, the retardation Δnd is in a range of 0.18 to 0.29, and the dielectric constant anisotropy Δ∈ is in a range of −7.5 to −4, in a material of a liquid crystal layer for a green color, the retardation Δnd is in a range of 0.25 to 0.38, and the dielectric constant anisotropy Δ∈ is in a range of −7.5 to −4, and in a liquid crystal material for a red color, the retardation Δnd is in a range of 0.31 to 0.45, and the dielectric constant anisotropy Δ∈ is in a range of −7.5 to −4.Δ∈

### BACKGROUND

1. Technical Field

The present invention relates to a liquid crystal device and a projector.

2. Related Art

As a liquid crystal device, for example, there is known a liquid crystal device of an active driving type, which includes a transistor for controlling a pixel electrode to be switched in each pixel. The liquid crystal device is used, for example, as a liquid crystal light valve of a liquid crystal projector as an electronic device.

Specifically, as an excellent contrast when observed from the front, for example, as disclosed in JP-A-2014-66961, there is proposed a liquid crystal projector, which includes a liquid crystal light valve (liquid crystal device) of a vertical alignment (hereinafter, referred to as VA) mode. In the liquid crystal light valve of the VA mode, a liquid crystal layer having a negative dielectric constant anisotropy is pinched between a pair of substrates, and liquid crystal molecules are substantially vertically oriented in a state in which a voltage is not applied.

In the liquid crystal projector, liquid crystal light valve (liquid crystal device) is disposed in each of the colors of blue (B), green (G), and red (R).

However, according to a high-definition and a high-brightness device, as illustrated in FIG. 10, in the relationship of transmissivity (VT characteristics) and the voltage corresponding to each of the colors (BGR), a difference in the amount of change becomes apparent, and there is a problem in that an item of display quality, such as chromaticity, is required to be improved. Particularly, a value of a property of a liquid crystal changes in response to a change in the temperature characteristics of the liquid crystal device (panel) due to having high brightness. In addition, as illustrated in FIG. 10, since the type of the VT characteristics in each of the BGR is different, the amount of change of each panel of the BGR with respect to the temperature change is notably different, and as a result, there is a problem in that display quality is deteriorated.

### SUMMARY

The invention can be realized in the following aspects or application examples.

### Application Example 1

According to this application example, there is provided a liquid crystal device for a blue color in which a liquid crystal layer including a liquid crystal material for a blue color of a vertical alignment type is pinched between a pair of substrates, in which, in the liquid crystal material for a blue color, the retardation Δnd is in a range of 0.18 to 0.29, and the dielectric constant anisotropy Δ∈ is in a range of −7.5 to −4.

According to the application example, the relationship between the physical property values (Δnd and Δ∈) of the liquid crystal material for a blue color is set to the range described above and used, and thus the VT characteristics of the liquid crystal material for a blue color can be matched to the VT characteristics of the liquid crystal materials of the other colors (for example, green and red). Accordingly, for example, even in a case in which the physical property value of the liquid crystal material is changed due to an increase in temperature, or the like, the difference in the amount of change in transmissivity with respect to the voltage is reduced, and thus deterioration of display quality can be suppressed.

### Application Example 2

According to this application example, there is provided a liquid crystal device for a green color in which a liquid crystal layer including a liquid crystal material for a green color of a vertical alignment type is pinched between a pair of substrates, in which, in the liquid crystal material for a green color, the retardation Δnd is in a range of 0.25 to 0.38, and the dielectric constant anisotropy Δ∈ is in a range of −7.5 to −4.

According to the application example, the relationship between the physical property values (Δnd and Δ∈) of the liquid crystal material for a green color is set to the range described above and used, and thus the VT characteristics of the liquid crystal material for a green color can be matched to the VT characteristics of the liquid crystal materials of the other colors (for example, blue and red). Accordingly, for example, even in a case in which the physical property value of the liquid crystal material is changed due to an increase in temperature, or the like, the difference in the amount of change in transmissivity with respect to the voltage is reduced, and thus deterioration of display quality can be suppressed.

### Application Example 3

According to this application example, there is provided a liquid crystal device for a red color in which a liquid crystal layer including a liquid crystal material for a red color of a vertical alignment type is pinched between a pair of substrates, in which, in the liquid crystal material for a red color, the retardation Δnd is in a range of 0.31 to 0.45, and the dielectric constant anisotropy Δ∈ is in a range of −7.5 to −4.

According to the application example, the relationship between the physical property values (Δnd and Δ∈) of the liquid crystal material for a red color is set to the range described above and used, and thus the VT characteristics of the liquid crystal material for a red color can be matched to the VT characteristics of the liquid crystal materials of the other colors (for example, blue and green). Accordingly, for example, even in a case in which the physical property value of the liquid crystal material is changed due to an increase of temperature, or the like, the difference in the amount of change in transmissivity with respect to the voltage is reduced, and thus deterioration of display quality can be suppressed.

### Application Example 4

According to this application example, there is provided a projector including a liquid crystal device for a blue color in which a liquid crystal layer including a liquid crystal material for a blue color of a vertical alignment type is pinched between a pair of substrates, a liquid crystal device for a green color in which a liquid crystal layer including a liquid crystal material for a green color of a vertical alignment type is pinched between a pair of substrates, and a liquid crystal device for a red color in which a liquid crystal layer including a liquid crystal material for a red color of a vertical alignment type is pinched between a pair of substrates, in which, in the liquid crystal material for a blue color, the retardation Δnd is in a range of 0.18 to 0.29, and the dielectric constant anisotropy Δ∈ is in a range of −7.5 to −4, in the liquid crystal material for a green color, the retardation Δnd is in a range of 0.25 to 0.38, and the dielectric constant anisotropy Δ∈ is in a range of −7.5 to −4, and in the liquid crystal material for a red color, the retardation Δnd is in a range of 0.31 to 0.45, and the dielectric constant anisotropy Δ∈ is in a range of −7.5 to −4.

According to the application example, the relationship between the physical property values (Δnd and Δ∈) of the liquid crystal materials for each color (blue, green, and red) is set to the range described above and used, and thus the VT characteristics of the liquid crystal material for each color can be matched to each other. Accordingly, for example, even in a case in which the physical property value of the liquid crystal material is changed due to an increase in temperature, or the like, the difference in the amount of change in transmissivity with respect to the voltage is reduced, and thus deterioration of display quality can be suppressed. Specifically, the projector can be optimally used in a range of 3.5V to 5V of an applying voltage.

### Application Example 5

In the projector according to the application example, it is preferable that, in the liquid crystal material for a blue color, the retardation Δnd is in a range of 0.20 to 0.29, and the dielectric constant anisotropy Δ∈ is in a range of −7.5 to −4, in the liquid crystal material for a green color, the retardation Δnd is in a range of 0.27 to 0.38, and the dielectric constant anisotropy Δ∈ is in a range of −7.5 to −4, and in the liquid crystal material for a red color, the retardation Δnd is in a range of 0.34 to 0.45, and the dielectric constant anisotropy Δ∈ is in a range of −7.5 to −4.

According to the application example, the relationship between the physical property values (Δnd and Δ∈) of the liquid crystal materials for each color (blue, green, and red) is set to the range described above and used, thus the VT characteristics of the liquid crystal material for each color can be matched to each other. Accordingly, for example, even in a case in which the physical property value of the liquid crystal material is changed due to an increase in temperature, or the like, the difference in the amount of change in transmissivity with respect to the voltage is reduced, and thus deterioration of display quality can be suppressed. Specifically, the projector can be optimally used in a range of the applying a voltage of 4V or less.

### Application Example 6

In the projector according to the application example, it is preferable that a gap of the liquid crystal layer for a blue color is in a range of 1.18 to 1.80, and the dielectric constant anisotropy Δ∈ of the liquid crystal material for a blue color is in a range of −7.5 to −4, a gap of the liquid crystal layer for a green color is in a range of 1.58 to 2.40, and the dielectric constant anisotropy Δ∈ of the liquid crystal material for a green color is in a range of −7.5 to −4, and a gap of the liquid crystal layer for a red color is in a range of 1.99 to 2.80, and the dielectric constant anisotropy Δ∈ of the liquid crystal material for a red color is in a range of −7.5 to −4.

According to the application example, the relationship between the physical property values (gap and Δ∈) of the liquid crystal materials of each color (blue, green, and red) is set to the range described above and used, and thus the VT characteristics of the liquid crystal material of each color can be matched to each other. Accordingly, for example, even in a case in which the physical property value of the liquid crystal material is changed due to an increase in temperature, or the like, the difference in the amount of change in transmissivity with respect to the voltage is reduced, and thus deterioration of display quality can be suppressed. Specifically, the projector can be optimally used in a range of 3.5V to 5V of the applying voltage.

### Application Example 7

In the projector according to the application example, it is preferable that the gap of the liquid crystal layer for a blue color is in a range of 1.18 to 1.80, and the dielectric constant anisotropy Δ∈ of the liquid crystal material for a blue color is in a range of −5.5 to −4, the gap of the liquid crystal layer for a green color is in a range of 1.58 to 2.20, and the dielectric constant anisotropy Δ∈ of the liquid crystal material for a green color is in a range of −6.5 to −5, and the gap of the liquid crystal layer for a red color is in a range of 1.99 to 2.60, and the dielectric constant anisotropy Δ∈ of the liquid crystal material for a red color is in a range of −7.5 to −6.

According to the application example, the relationship between the physical property values (gap and Δ∈) of the liquid crystal materials of each color (blue, green, and red) is set to the range described above and used, and thus the VT characteristics of the liquid crystal material of each color can be matched to each other. Accordingly, for example, even in a case in which the physical property value of the liquid crystal material is changed due to an increase in temperature, or the like, the difference in the amount of change in transmissivity with respect to the voltage is reduced, and thus deterioration of display quality can be suppressed. Further, while maintaining the VT characteristics, widening of the gap which largely affects a domain can be suppressed. Accordingly, deterioration of display quality due to the domain can be suppressed.

### Application Example 8

In the projector according to the application example, it is preferable that, in the liquid crystal material for a blue color, the retardation Δnd is in a range of 0.18 to 0.29, and the dielectric constant anisotropy Δ∈×a voltage V² is in a range of −120 to −64, in the liquid crystal material for a green color, the retardation Δnd is in a range of 0.25 to 0.38, and the dielectric constant anisotropy Δ∈×the voltage V² is in a range of −120 to −64, and in the liquid crystal material for a red color, the retardation Δnd is in a range of 0.31 to 0.45, and the dielectric constant anisotropy Δ∈× the voltage V² is in a range of −120 to −64.

According to the application example, a relationship between the physical property values (Δnd and Δ∈×V²) of the liquid crystal materials of each color (for blue, for green, and for red) is set to the range described above and used, and thus the VT characteristics of the liquid crystal material of each color can be matched to each other. Accordingly, for example, even in a case in which the physical property value of the liquid crystal material is changed due to an increase of temperature, or the like, the difference of the amount of change in the transmissivity with respect to the voltage is reduced, and thus deterioration of display quality can be suppressed.

### Application Example 9

According to this application example, there is provided a liquid crystal device for a blue color in which a liquid crystal layer including a liquid crystal material for a blue color of a vertical alignment type is pinched between a pair of substrates, in which, in the liquid crystal material for a blue color, the retardation 2Δnd is in a range of 0.18 to 0.29, and the dielectric constant anisotropy Δ∈ is in a range of −7.5 to −4.

According to the application example, a relationship between the physical property values (2Δnd and Δ∈) of the liquid crystal material for a blue color is set to the range described above and used, and thus the VT characteristics of the reflective type liquid crystal material for a blue color can be matched to the VT characteristics of the liquid crystal materials for the other colors (for example, green and red). Accordingly, for example, even in a case in which the physical property value of the liquid crystal material is changed due to an increase of temperature, or the like, the difference in the amount of change in the transmissivity with respect to the voltage is reduced, and thus deterioration of display quality can be suppressed.

### Application Example 10

According to this application example, there is provided a liquid crystal device for a green color in which a liquid crystal layer including a liquid crystal material for a green color of a vertical alignment type is pinched between a pair of substrates, in which in the liquid crystal material for a green color, the retardation 2Δnd is in a range of 0.25 to 0.38, and the dielectric constant anisotropy Δ∈ is in a range of −7.5 to −4.

According to the application example, a relationship between the physical property values (2Δnd and Δ∈) of the liquid crystal material for a green color is set to the range described above and used, and thus the VT characteristics of the reflective type liquid crystal material for a green color can be matched to the VT characteristics of the liquid crystal materials for the other colors (for example, blue and red). Accordingly, for example, even in a case in which the physical property value of the liquid crystal material is changed due to an increase of temperature, or the like, the difference of the amount of change in the transmissivity with respect to the voltage is reduced, and thus deterioration of display quality can be suppressed.

### Application Example 11

According to this application example, there is provided a liquid crystal device for a red color in which a liquid crystal layer including a liquid crystal material for a red color of a vertical alignment type is pinched between a pair of substrates, in which in the liquid crystal material for a red color, the retardation 2Δnd is in a range of 0.31 to 0.45, and the dielectric constant anisotropy Δ∈ is in a range of −7.5 to −4.

According to the application example, a relationship between the physical property values (2Δnd and Δ∈) of the liquid crystal material for a red color is set to the range described above and used, and thus the VT characteristics of the reflective type liquid crystal material for a red color can be matched to the VT characteristics of the liquid crystal materials for the other colors (for example, blue and green). Accordingly, for example, even in a case in which the physical property value of the liquid crystal material is changed due to an increase of temperature, or the like, the difference of the amount of change in the transmissivity with respect to the voltage is reduced, and thus deterioration of display quality can be suppressed.

### Application Example 12

According to this application example, there is provided a projector including a liquid crystal device for a blue color in which a liquid crystal layer including a liquid crystal material for a blue color of a vertical alignment type is pinched between a pair of substrates, a liquid crystal device for a green color in which a liquid crystal layer including a liquid crystal material for a green color of a vertical alignment type is pinched between a pair of substrates, and a liquid crystal device for a red color in which a liquid crystal layer including a liquid crystal material for a red color of a vertical alignment type is pinched between a pair of substrates, in which in the liquid crystal material for a blue color, the retardation 2Δnd is in a range of 0.18 to 0.29, and the dielectric constant anisotropy Δ∈ is in a range of −7.5 to −4, in the liquid crystal material for a green color, the retardation 2Δnd is in a range of 0.25 to 0.38, and the dielectric constant anisotropy Δ∈ is in a range of −7.5 to −4, and in the liquid crystal material for a red color, the retardation 2Δnd is in a range of 0.31 to 0.45, and the dielectric constant anisotropy Δ∈ is in a range of −7.5 to −4.

According to the application example, a relationship between the physical property values (2Δnd and Δ∈) of the liquid crystal material of each color (for blue, for green, and for red) is set to the range described above and used, and thus the VT characteristics of the reflective type liquid crystal material of each color can be matched to each other. Accordingly, for example, even in a case in which the physical property value of the liquid crystal material is changed due to an increase of temperature, or the like, the difference of the amount of change in the transmissivity with respect to the voltage is reduced, and thus deterioration of display quality can be suppressed. Specifically, it can be optimally used in a range of 3.5V to 5V of the applying voltage.

### Application Example 13

In the projector according to the application example, it is preferable that, in the liquid crystal material for a blue color, the retardation 2Δnd is in a range of 0.20 to 0.29, and the dielectric constant anisotropy Δ∈ is in a range of −7.5 to −4, in the liquid crystal material for a green color, the retardation 2Δnd is in a range of 0.27 to 0.38, and the dielectric constant anisotropy Δ∈ is in a range of −7.5 to −4, and in the liquid crystal material for a red color, the retardation 2Δnd is in a range of 0.34 to 0.45, and the dielectric constant anisotropy Δ∈ is in a range of −7.5 to −4.

According to the application example, a relationship between the physical property values (2Δnd and Δ∈) of the liquid crystal material of each color (for blue, for green, and for red) is set to the range described above and used, and thus the VT characteristics of the reflective type liquid crystal material of each color can be matched to each other. Accordingly, for example, even in a case in which the physical property value of the liquid crystal material is changed due to an increase of temperature, or the like, the difference of the amount of change in transmissivity with respect to the voltage is reduced, and thus deterioration of display quality can be suppressed. Specifically, it can be optimally used in a range of 4V or less of the applying voltage.

### Application Example 14

In the projector according to the application example, it is preferable that the gap of the liquid crystal layer for a blue color is in a range of 1.18 to 1.80, and the dielectric constant anisotropy Δ∈ of the liquid crystal material for a blue color is in a range of −7.5 to −4, the gap of the liquid crystal layer for a green color is in a range of 1.58 to 2.40, and the dielectric constant anisotropy Δ∈ of the liquid crystal material for a green color is in a range of −7.5 to −4, and the gap of the liquid crystal layer for a red color is in a range of 1.99 to 2.80, and the dielectric constant anisotropy Δ∈ of the liquid crystal material for a red color is in a range of −7.5 to −4.

According to the application example, a relationship between the physical property values (gap and Δ∈) of the liquid crystal materials of each color (for blue, for green, and for red) is set to the range described above and used, the VT characteristics of the reflective type liquid crystal material of each color can be matched to each other. Accordingly, for example, even in a case in which the physical property value of the liquid crystal material is changed due to an increase of temperature, or the like, the difference in the amount of change in transmissivity with respect to the voltage is reduced, and thus deterioration of display quality can be suppressed. Specifically, it can be optimally used in a range of 3.5V to 5V of the applying voltage.

### Application Example 15

In the projector according to the application example, it is preferable that the gap of the liquid crystal layer for a blue color is in a range of 1.18 to 1.80, and the dielectric constant anisotropy Δ∈ of the liquid crystal material for a blue color is in a range of −5.5 to −4, the gap of the liquid crystal layer for a green color is in a range of 1.58 to 2.20, and the dielectric constant anisotropy Δ∈ of the liquid crystal material for a green color is in a range of −6.5 to −5, and the gap of the liquid crystal layer for a red color is in a range of 1.99 to 2.60, and the dielectric constant anisotropy Δ∈ of the liquid crystal material for a red color is in a range of −7.5 to −6.

According to the application example, a relationship between the physical property values (gap and Δ∈) of the liquid crystal materials of each color (for blue, for green, and for red) is set to the range described above and used, the VT characteristics of the reflective type liquid crystal material of each color can be matched to each other. Accordingly, for example, even in a case in which the physical property value of the liquid crystal material is changed due to an increase of temperature, or the like, the difference of the amount of change in transmissivity with respect to the voltage is reduced, and thus deterioration of display quality can be suppressed. Further, while maintaining the VT characteristics, widening of the gap which largely affects a domain can be suppressed. Accordingly, deterioration of display quality due to the domain can be suppressed.

### Application Example 16

In the projector according to the application example, it is preferable that, in the liquid crystal material for a blue color, the retardation 2Δnd is in a range of 0.18 to 0.29, and the dielectric constant anisotropy Δ∈× a voltage V² is in a range of −120 to −64, in the liquid crystal material for a green color, the retardation 2Δnd is in a range of 0.25 to 0.38, and the dielectric constant anisotropy Δ∈× the voltage V² is in a range of −120 to −64, and in the liquid crystal material for a red color, the retardation 2Δnd is in a range of 0.31 to 0.45, and the dielectric constant anisotropy Δ∈× the voltage V² is in a range of −120 to −64.

According to the application example, a relationship between the physical property values (2Δnd and Δ∈× V²) of the liquid crystal materials of each color (for blue, for green, and for red) is set to the range described above and used, the VT characteristics of the reflective type liquid crystal material of each color can be matched to each other. Accordingly, for example, even in a case in which the physical property value of the liquid crystal material is changed due to an increase of temperature, or the like, the difference of the amount of change in transmissivity with respect to the voltage is reduced, and thus deterioration of display quality can be suppressed.

### BRIEF DESCRIPTION OF THE DRAWINGS

The invention will be described with reference to the accompanying drawings, wherein like numbers reference like elements.

FIG. 1 is a perspective plan view illustrating a configuration of a liquid crystal device.

FIG. 2 is a perspective sectional view taken along line II-II of the liquid crystal device illustrated in FIG. 1.

FIG. 3 is an equivalent circuit diagram illustrating an electrical configuration of the liquid crystal device.

FIG. 4 is a schematic view illustrating a configuration of a projector as an electronic device.

FIG. 5 is a graph illustrating a relationship between the dielectric constant anisotropy Δ∈ and the retardation Δnd as blue (B), green (G), and red (R) in every voltage V.

FIG. 6 is a graph illustrating a relationship between the dielectric constant anisotropy Δ∈ and a GAP as blue (B), green (G), and red (R) in every voltage V.

FIG. 7 is a graph illustrating a relationship between the dielectric constant anisotropy Δ∈ and the GAP as blue (B), green (G), and red (R) in every voltage V.

FIG. 8 is a graph illustrating a relationship between a product of the dielectric constant anisotropy Δ∈ and an applying voltage V² and the retardation Δnd as blue (B), green (G), and red (R) in every voltage V.

FIG. 9 is a graph illustrating a relationship between the voltage V and a transmissivity in a case in which a dedicated liquid crystal device is used in each of colors (BGR).

FIG. 10 is a graph illustrating a relationship between a voltage V and a transmissivity of a liquid crystal device of the related art.

### DESCRIPTION OF EXEMPLARY EMBODIMENTS

Hereinafter, embodiments in which the invention is embodied will be described with reference to drawings. Moreover, the drawings to be used are illustrated to be appropriately enlarged or reduced so that parts to be described are able to be recognized.

Moreover, in a shape to be described hereinafter, for example, if “on a substrate” is disclosed, it indicates a case of being disposed in contact with the substrate, a case of being disposed on the substrate through another composition, or a case in which a part is disposed in contact with the substrate and the other part is disposed through another composition.

In this embodiment, an active matrix type liquid crystal device which includes a thin film transistor (TFT) as a switching element of pixels will be described as an example. The liquid crystal device can be appropriately used as, for example, a light modulation element (liquid crystal light valve) of an electronic device (projector) to be described later.

### Configuration of Liquid Crystal Device

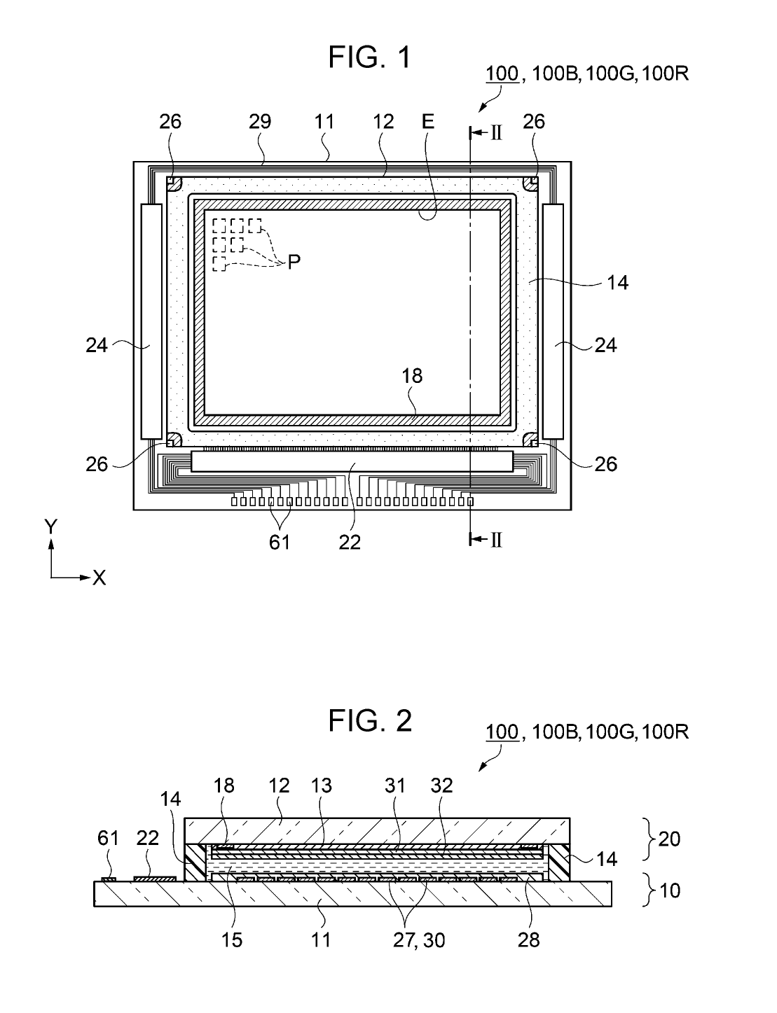

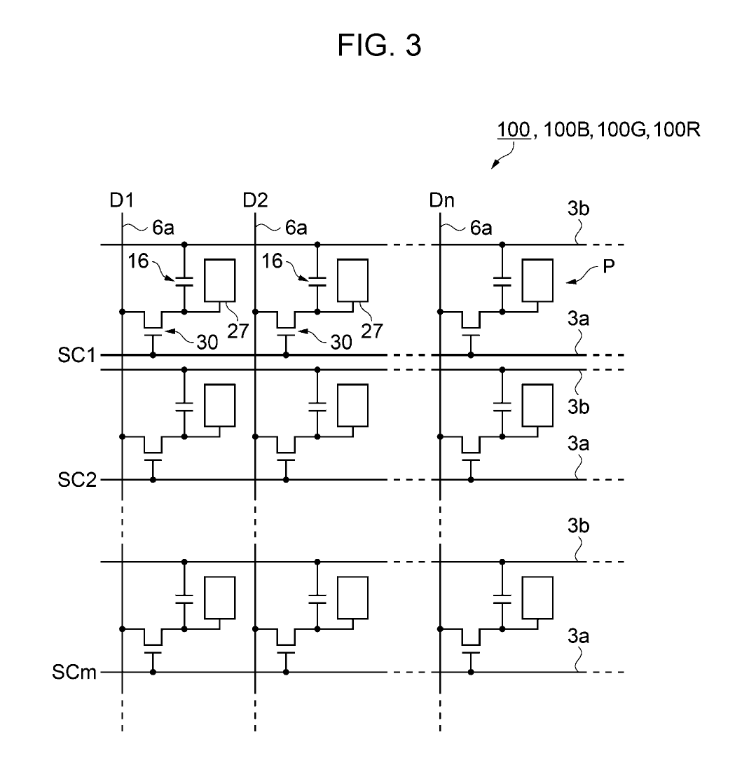

FIG. 1 is a perspective plan view illustrating a configuration of the liquid crystal device. FIG. 2 is a perspective sectional view taken along line II-II of the liquid crystal device illustrated in FIG. 1. FIG. 3 is an equivalent circuit diagram illustrating a specific configuration of the liquid crystal device. Hereinafter, the configuration of the liquid crystal device will be described with reference to FIG. 1 to FIG. 3.

As illustrated in FIG. 1 and FIG. 2, the liquid crystal device 100 of the embodiment includes an element substrate 10 and an opposite substrate 20 as a pair of substrates which are oppositely disposed, and a liquid crystal layer 15 which is pinched between a pair of the substrates. As a first base material 11 constituting the element substrate 10 and a second base material 12 constituting the opposite substrate 20, for example, a transparent substrate such as a glass substrate or a quartz substrate is used.

The element substrate 10 is larger than the opposite substrate 20, and both the substrates are bonded to each other through a seal material 14 which is disposed along a periphery of the opposite substrate 20, and the liquid crystal layer 15 in which a liquid crystal having a negative dielectric anisotropy is enclosed and an aperture thereof are provided.

As the seal material 14, for example, an adhesive such as a thermosetting or ultraviolet curable epoxy resin is adopted. In the seal material 14, a material for a gap for uniformly maintaining an interval between a pair of the substrates is mixed.

A display region E in which a plurality of pixels P are disposed is included inside the seal material 14. A light-shielding layer 18 (parting portion), which is made of, for example, a metal or a metallic oxide having a light blocking effect, is disposed between the seal material 14 and the display region E so as to surround the display region E. Moreover, the display region E may include a plurality of dummy pixels which are disposed so as to surround the plurality of pixels P contributing to display.

A data line driving circuit 22 is provided between a first side portion of the first base material 11 and the seal material 14 along the another first side portion. In addition, an inspection circuit (not illustrated) is provided inside the seal material 14 along the another first side portion facing the first side portion. Further, two scan line driving circuits 24 are provided in a second side portion which is orthogonal to and faces the first side portion. A plurality of wires 29 connecting the two scan line driving circuits 24 are provided in the other first side portion facing the first side portion.

The wires, which connect the data line driving circuit 22 and the scan line driving circuits 24, are connected to a plurality of external connection terminals 61 arranged along the first side portion. Hereinafter, a direction in which the first side portion extends is set to an X direction, and a direction of the other second side portion which is orthogonal to and faces the first side portion is set to a Y direction.

As illustrated in FIG. 2, on a surface of the liquid crystal layer 15 side of the first base material 11, the pixel electrode 27 made of a transparent electrode or the like, such as indium tin oxide (ITO), provided in each of the pixels P, and a thin film transistor 30 (hereinafter, referred to as “TFT 30”) as a switching element, signal wires, and the first alignment film 28, which covers these components, are formed.

In addition, a shielding structure, which prevents light from being incident on a semiconductor layer in the TFT 30 and a switching operation from becoming unstable, is adopted. As seen from above, the element substrate 10 includes at least the TFT 30, the pixel electrode 27, and the first alignment film 28.

A light-shielding layer 18, an insulation layer 13 which is formed to cover the light-shielding layer, a common electrode 31 which is provided to cover the insulation layer 13, and a second alignment film 32, which covers the common electrode 31, are provided on a surface of the liquid crystal layer 15 side of the second base material 12.

The common electrode 31 is made of a transparent conductive film such as ITO, covers the insulation layer, or the like, and is electrically connected to the element substrate 10 side by an upper and lower conduction portion 26, which is provided at four corners of the opposite substrate 20 as illustrated in FIG. 1.

The first alignment film 28 which covers the pixel electrode 27 and the second alignment film 32 which covers the common electrode 31 constitute an inorganic alignment layer and are selected based on the optical design of the liquid crystal device 100. For example, it is exemplified that an inorganic material such as SiOx (silicon oxide) is formed to be a film by a vapor phase growth method and is substantially vertically aligned with respect to the liquid crystal molecules. Such an opposite substrate 20 includes at least the common electrode 31 and the second alignment film 32.

Such a liquid crystal device 100 is, for example, a transmission type and adopts an optical design such as a normally black mode in which the pixels P become dark at the time of non-driving or a normally white mode in which the pixels become bright at the time of non-driving. According to the optical design, a polarizing plate is used by being disposed on an incident side (emitting side) of light.

As illustrated in FIG. 3, the liquid crystal device 100 includes at least a plurality of scan lines 3a and a plurality of data lines 6a that are insulated from each other and orthogonal to each other in the display region E, and capacitance lines 3b which extend parallel to the scan lines 3a. A direction in which the scan lines 3a extends is set in the X direction, and a direction in which the data lines 6a extend is set to the Y direction. Moreover, the capacitance lines 3b can be disposed so as to extend parallel to the data lines 6a.

The scan lines 3a, the data lines 6a, the capacitance lines 3b, the pixel electrode 27, the TFT 30, and the capacitance elements 16, which are provided in regions divided by these signal lines types constitute a pixel circuit of the pixels P.

The scan lines 3a are electrically connected to a gate of the TFT 30, and the data lines 6a are electrically connected to a source and drain region of the data lines side of the TFT 30. The pixel electrode 27 is electrically connected to a source and drain region of the pixel electrode side of the TFT 30.

The data lines 6a are connected to the data line driving circuit 22 (refer to FIG. 1), and supply image signals D1, D2, . . . , Dn are supplied from the data line driving circuit 22 to the pixels P. The scan lines 3a are connected to the scan line driving circuit 24 (refer to FIG. 1), and supply scan signals SC1, SC2, . . . , SCm are supplied from the scan line driving circuit 24 to each of the pixels P.

The image signals D1 to Dn, which are supplied from the data line driving circuit 22 to the data lines 6a, may be supplied in this sequence, or may be supplied at the same time with respect to a plurality of data lines 6a which are adjacent with each other. The scan line driving circuit 24 sequentially supplies the scan signals SC1 to SCm in a pulse at a predetermined timing with respect to the scan lines 3a.

The liquid crystal device 100 is formed so that the TFT 30, which is a switching element, is turned on at a predetermined timing by inputting the scan signals SC1 to SCm, and so that the image signals D1 to Dn supplied from the data lines 6a are written in the pixel electrode 27 at a predetermined timing. Also, the image signals D1 to Dn written at a predetermined level to the liquid crystal layer 15 through the pixel electrode 27 are maintained at a certain period between the pixel electrode 27 and the common electrode 31 disposed to face the electrode through the liquid crystal layer 15.

In order to prevent the maintained image signals D1 to Dn from being leaked, the capacitance elements 16 are connected parallel to a liquid crystal capacitor disposed between the pixel electrode 27 and the common electrode 31. The capacitance elements 16 are provided between a source and drain region of the pixel electrode side of the TFT 30 and the capacitance lines 3b.

### Configuration of Electronic Device

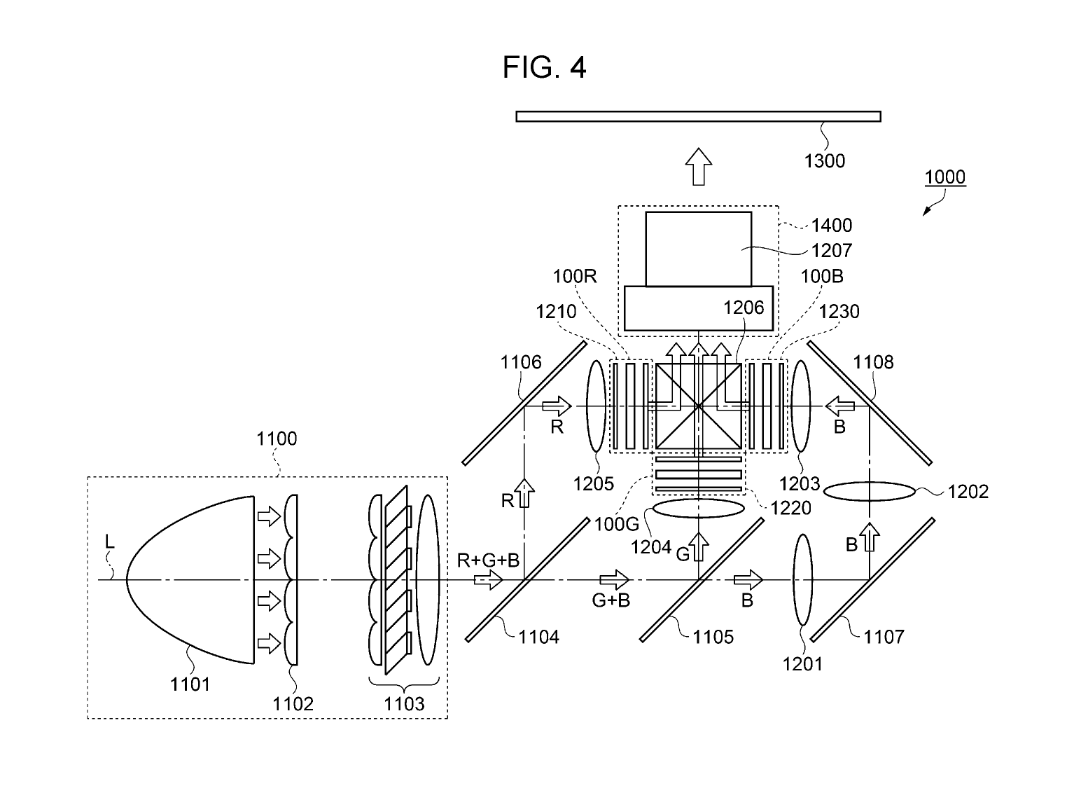

FIG. 4 is a schematic view illustrating a configuration of the projector as an electronic device. Hereinafter, the configuration of the projector will be described with reference to FIG. 4.

As illustrated in FIG. 4, the projector 1000 of the embodiment is provided with a polarization lighting device 1100 as a lighting system disposed along a system optical axis L, two dichroic mirrors 1104 and 1105 as an optical separating element, three reflection mirrors 1106, 1107, and 1108, five relay lenses 1201, 1202, 1203, 1204, and 1205, liquid crystal light valves 1210, 1220, and 1230 of a transmission type as three optical modulation devices, a cross dichroic prism 1206 as a photosynthetic element, and a projection lens 1207.

The polarization lighting device 1100 is schematically configured with a lamp unit 1101 as a light source which is made of a white light source such as an ultra-high pressure mercury lamp or halogen lamp, a integrator lens 1102, and a polarization conversion element 1103.

The dichroic mirror 1104 reflects red color light (R), and transmits green color light (G) and blue color light (B) among polarized light fluxes emitted from the polarization lighting device 1100. Also, one dichroic mirror 1105 reflects the green color light (G) transmitted through the dichroic mirror 1104, and transmits the blue color light (B).

The red color light (R) reflected to the dichroic mirror 1104 is incident on the liquid crystal light valve 1210 through the relay lens 1205 after being reflected to the reflection mirror 1106. The green color light (G) reflected to the dichroic mirror 1105 is incident on the liquid crystal light valve 1220 through the relay lens 1204. The blue color light (B) transmitted through the dichroic mirror 1105 is incident on the liquid crystal light valve 1230 through a conduction system made of three relay lenses 1201, 1202, and 1203 and two reflection mirrors 1107 and 1108.

The liquid crystal light valves 1210, 1220, and 1230 are disposed in a facing manner with respect to an incident surface in each of color light of the cross dichroic prism 1206. The color light incident to the liquid crystal light valves 1210, 1220, and 1230, is emitted toward the cross dichroic prism 1206 which is modulated based on video information (video signal).

The prism is formed when four right angle prisms are attached, and a dielectric multilayer film reflecting the red color light and a dielectric multilayer film reflecting the blue color light are formed on an internal surface thereof in a cross shape. Three colors of light are combined by the dielectric multilayer films, and light displaying a color image is combined. The combined light is projected by a projection lens 1207 constituting a projection optical system 1400 on a screen 1300, and an image is displayed to be enlarged.

The liquid crystal device 100 (100R) is applied to the liquid crystal light valve 1210. The liquid crystal device 100 is disposed with an aperture between a pair of polarization light elements which are disposed in a cross nicol on an incident side and an emitting side of the color light. The other liquid crystal light valves 1220 and 1230 are also the same.

Since an electronic device having such a configuration uses the liquid crystal device 100 of the embodiment described above, the projector 1000 which has high reliability and an excellent display characteristic can be provided.

### Characteristic Evaluation

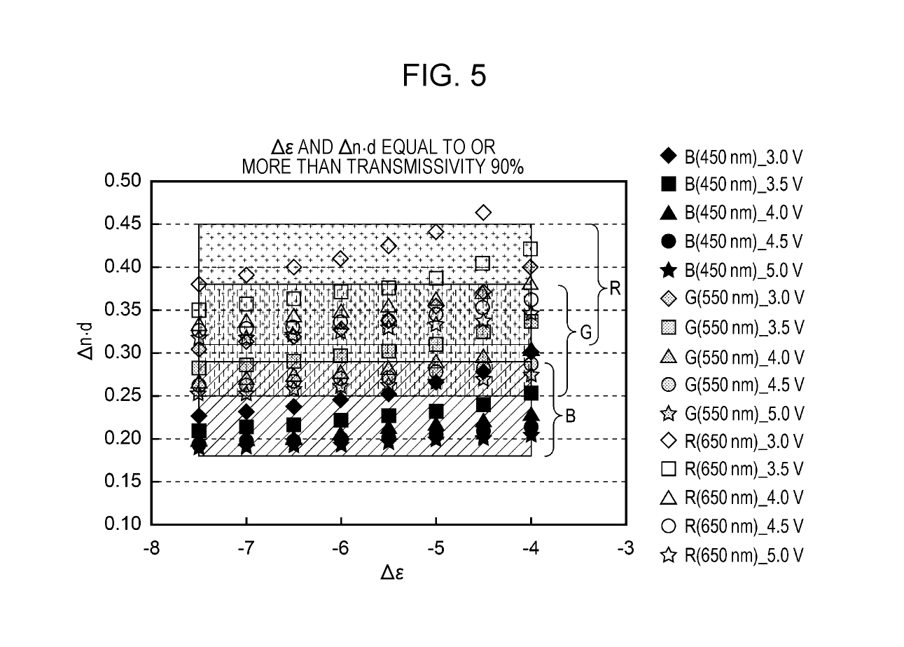

FIG. 5 is a graph illustrating a relationship between the dielectric constant anisotropy Δ∈ and the retardation Δnd as blue (B), green (G), and red (R) in every voltage V. Hereinafter, the relationship between the dielectric constant anisotropy Δ∈ and the retardation Δnd will be described with reference to FIG. 5.

In the graph illustrated in FIG. 5, the dielectric constant anisotropy Δ∈ is illustrated in a horizontal axis, and the retardation Δnd is illustrated in a vertical axis. Δn is a refractive index anisotropy, and in the embodiment, a liquid crystal of which the Δn is 0.16 is used. d is a cell gap. The dielectric constant anisotropy Δ∈ of the horizontal axis indicates a range of −8 to −3. The retardation Δnd of the vertical axis indicates a range of 0.1 to 0.5.

In addition, a plurality of points illustrated in the graph of FIG. 5 are written for the entirety of a relationship of which a transmissivity is equal to or more than 90% in a relationship between the dielectric constant anisotropy Δ∈ and the retardation Δnd. In addition, in a case in which an applying voltage of the liquid crystal is set to a range of 0V to 5V, a value every 0.5V from 3V to 5V is calculated, and an optimum range in each color is set.

As illustrated in FIG. 5, it is preferable that as a physical property value of B (for blue) of a liquid crystal material, the dielectric constant anisotropy Δ∈ is set in a range of −7.5 to −4, and the retardation Δnd is set in a range of 0.18 to 0.29.

In addition, it is preferable that as a physical property value of a liquid crystal material of G (for green), the dielectric constant anisotropy Δ∈ is set in a range of −7.5 to −4, and the retardation Δnd is set in a range of 0.25 to 0.38.

In addition, it is preferable that a physical property value of a liquid crystal material of R (for red), the dielectric constant anisotropy Δ∈ is set in a range of −7.5 to −4, and the retardation Δnd is set in a range of 0.31 to 0.45.

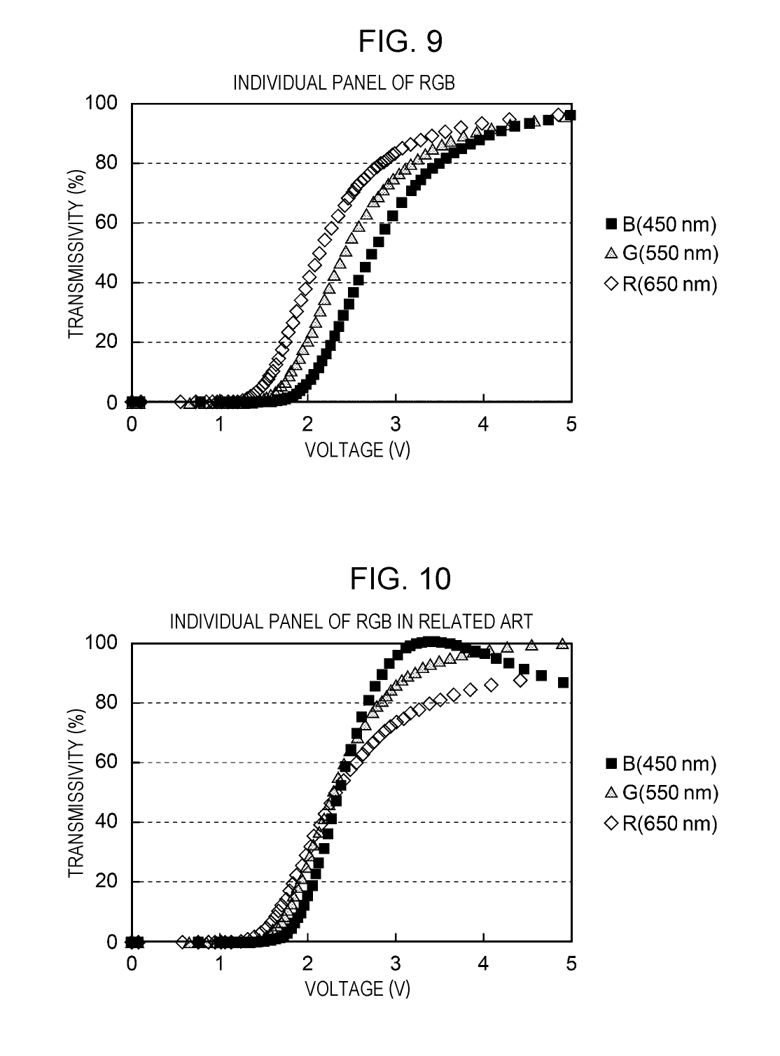

When a physical property value of a liquid crystal material of each of the liquid crystal devices 100B, 100G, and 100R is set to become each relationship as illustrated in FIG. 5, VT characteristics of each of the liquid crystal devices 100B, 100G, and 100R can be provided (refer to FIG. 9). Accordingly, for example, even in a case in which the physical property value of the liquid crystal material is changed due to an increase of temperature, or the like, a difference of an amount of change in transmissivity with respect to the voltage is reduced, and thus deterioration of display quality can be suppressed. In a case of FIG. 5, it can be optimally used for a case in which the applying voltage is in a range of 3.5V to 5V.

In addition, in a case in which a voltage used is equal to or less than the applying voltage 4V, it is preferable that as the physical property value of the liquid crystal material of B (for blue), the dielectric constant anisotropy Δ∈ is set in a range of −7.5 to −4, and the retardation Δnd is set in a range of 0.20 to 0.29.

In addition, it is preferable that as the physical property value of the liquid crystal material of G (for green), the dielectric constant anisotropy Δ∈ is set in a range of −7.5 to −4, and the retardation Δnd is set in a range of 0.27 to 0.38.

In addition, it is preferable that as the physical property value of the liquid crystal material of R (for red), the dielectric constant anisotropy Δ∈ is set in a range of −7.5 to −4, and the retardation Δnd is set in a range of 0.34 to 0.45.

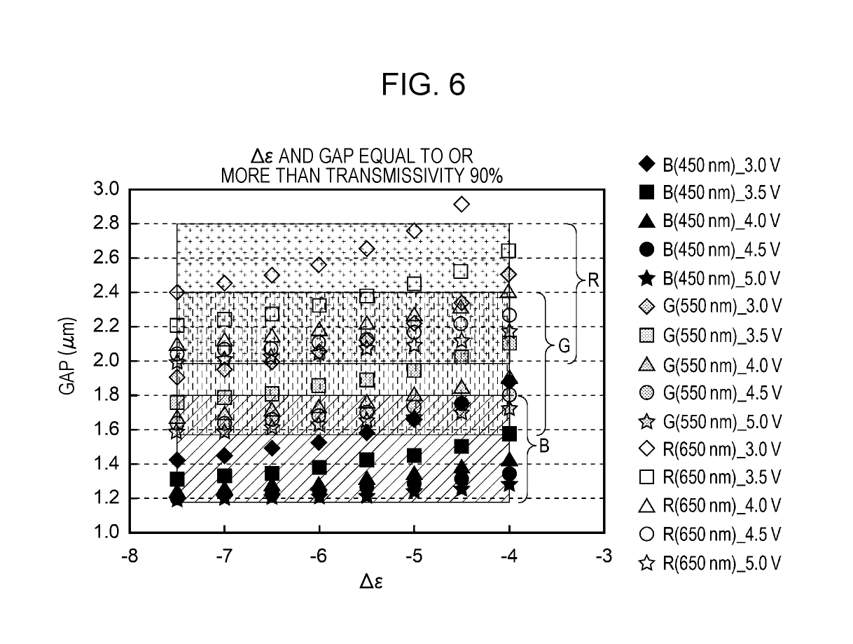

FIG. 6 is a graph illustrating a relationship between the dielectric constant anisotropy Δ∈ and a cell gap (GAP) (μm) as blue (B), green (G), and red (R) in every voltage V. Hereinafter, the relationship between the dielectric constant anisotropy Δ∈ and the GAP will be described with reference to FIG. 6.

The graph in FIG. 6 illustrates the dielectric constant anisotropy Δ∈ in a horizontal axis, and the GAP (μm) in a vertical axis. The dielectric constant anisotropy Δ∈ in the horizontal axis indicates a range of −8 to −3. The GAP in the vertical axis indicates a range of 1 μm to 3 μm.

In addition, a plurality of points illustrated in the graph of FIG. 6 are written for the entirety of a relationship of which a transmissivity is equal to or more than 90% in a relationship between the dielectric constant anisotropy Δ∈ and the GAP. In addition, in a case in which the applying voltage of the liquid crystal is set in a range of 0V to 5V, a value every 0.5V from 3V to 5V is calculated, and an optimum range in each color is set.

As illustrated in FIG. 6, it is preferable that as the physical property value of the liquid crystal material of B (for blue), the dielectric constant anisotropy Δ∈ is set in a range of −7.5 to −4, and the GAP is set in a range of 1.18 μm to 1.8 μm.

In addition, it is preferable that as the physical property value of the liquid crystal material of G (for green), the dielectric constant anisotropy Δ∈ is set in a range of −7.5 to −4, and the GAP is set in a range of 1.58 μm to 2.4 μm.

In addition, it is preferable that as the physical property value of the liquid crystal material of R (for red), the dielectric constant anisotropy Δ∈ is set in a range of −7.5 to −4, and the GAP is set in a range of 1.99 μm to 2.8 μm.

When the physical property value of the liquid crystal material of each of the liquid crystal devices 100B, 100G, and 100R is set to become each relationship as illustrated FIG. 6, the VT characteristics of each of the liquid crystal devices 100B, 100G, and 100R can be matched to each other (refer to FIG. 9). Accordingly, for example, even in a case in which the physical property value of the liquid crystal material is changed due to an increase of temperature, or the like, the difference of the amount of change in transmissivity with respect to the voltage is reduced, and thus deterioration of display quality can be suppressed. In a case of FIG. 6, it can be optimally used for a case in which the applying voltage is in a range of 3.5V to 5V.

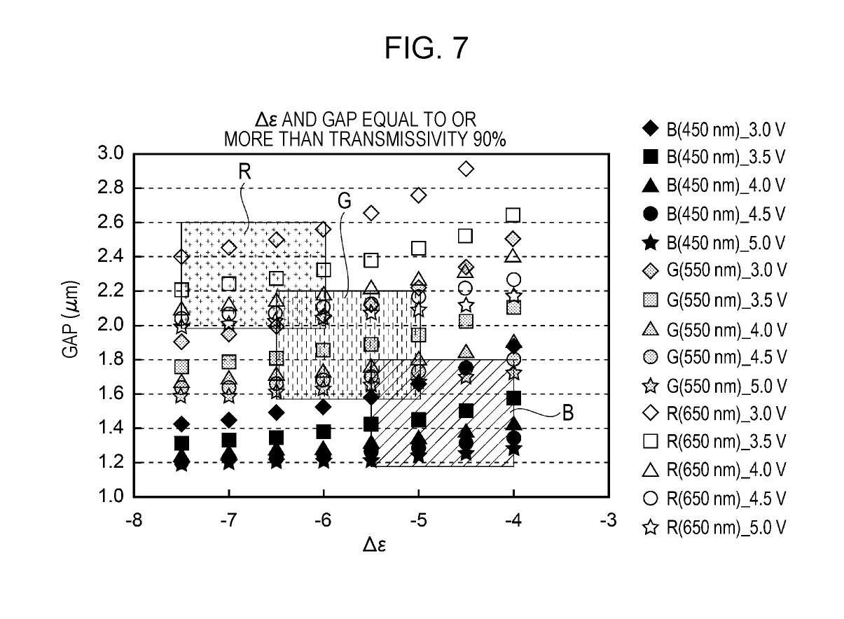

FIG. 7 is a graph illustrating a relationship between the dielectric constant anisotropy Δ∈ and a cell gap (GAP) (μm) as blue (B), green (G), and red (R) in every voltage V. Hereinafter, the relationship between the dielectric constant anisotropy Δ∈ and the GAP will be described with reference to FIG. 7.

In the graph in FIG. 7, compared to the graph illustrated in FIG. 6, a region which becomes a more optimum range is set, and the others are the same as that of the graph illustrated in FIG. 6.

As illustrated in FIG. 7, it is preferable that as the physical property value of the liquid crystal material of B (for blue), the dielectric constant anisotropy Δ∈ is set in a range of −5.5 to −4, and the GAP is set in a range of 1.18 μm to 1.8 μm.

In addition, it is preferable that as the physical property value of the liquid crystal material of G (for green), the dielectric constant anisotropy Δ∈ is set in a range of −6.5 to −5, and the GAP is set in a range of 1.58 μm to 2.20 μm.

In addition, it is preferable that as the physical property value of the liquid crystal material of R (for red), the dielectric constant anisotropy Δ∈ is set in a range of −7.5 to −6, and the GAP is set in a range of 1.99 μm to 2.6 μm.

When the physical property value of the liquid crystal material of each of the liquid crystal devices 100B, 100G, and 100R is set to become each relationship as illustrated in FIG. 7, the VT characteristics of each of the liquid crystal devices 100B, 100G, and 100R can be matched to each other (refer to FIG. 9). Accordingly, for example, even in a case in which the physical property value of the liquid crystal material is changed due to an increase of temperature, or the like, the difference of the amount of change in transmissivity with respect to the voltage is reduced, and thus deterioration of display quality can be suppressed.

Further, when setting to the relationship as illustrated in FIG. 7, while maintaining the VT characteristics, widening the gap which largely affects a domain can be suppressed. Accordingly, deterioration of display quality due to the domain can be suppressed.

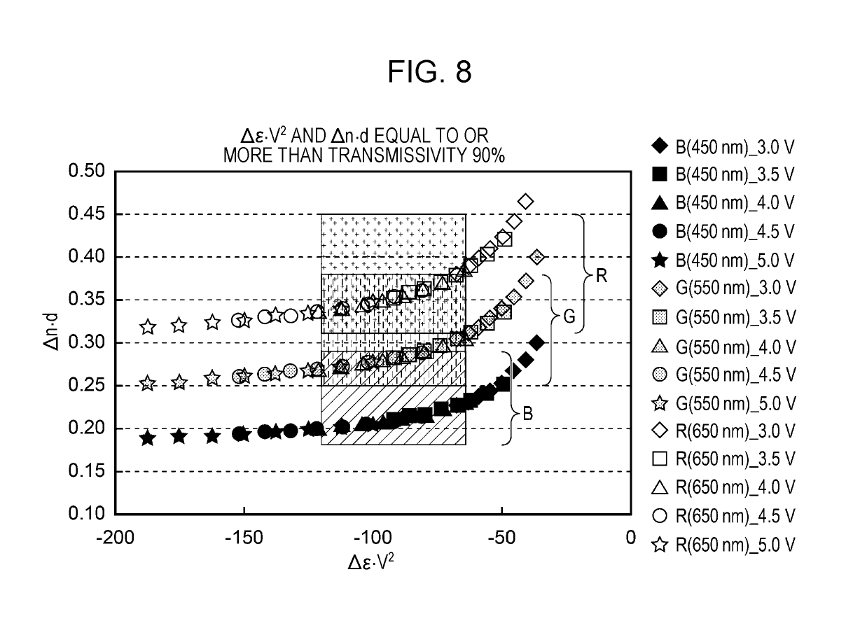

FIG. 8 is a graph illustrating a relationship between a product of the dielectric constant anisotropy Δ∈ and the applying voltage V² and the retardation Δnd, as blue (B), green (G), and red (R) in every the voltage V. Hereinafter, the relationship between the product of the dielectric constant anisotropy Δ∈ and the applying voltage V² and the retardation Δnd will be described with reference to FIG. 8.

The graph in FIG. 8 illustrates the product of the dielectric constant anisotropy Δ∈ and the applying voltage V² in a horizontal axis, and the retardation Δnd in the vertical axis. The product of the dielectric constant anisotropy Δ∈ and the applying voltage V² indicates a range of 0 to −200. The retardation Δnd in the vertical axis indicates a range of 0.1 to 0.5.

In addition, a plurality of points illustrated in the graph of FIG. 8 are written for the entirety of a relationship of which a transmissivity is equal to or more than 90% in the relationship between the product of the dielectric constant anisotropy Δ∈ and the applying voltage V² and the retardation Δnd. In addition, in a case in which the applying voltage of the liquid crystal is set in a range of 0V to 5V, a value every 0.5V from 3V to 5V is calculated, and an optimum range in each color is set.

As illustrated in FIG. 8, it is preferable that as the physical property value of the liquid crystal material of B (for blue), the retardation Δnd is set in a range of 0.18 to 0.29, and the dielectric constant anisotropy Δ∈×the voltage V² is set in a range of −120 to −64.

In addition, it is preferable that as the physical property value of the liquid crystal material of G (for green), the retardation Δnd is set in a range of 0.25 to 0.38, and the dielectric constant anisotropy Δ∈×the voltage V² is set in a range of −120 to −64.

In addition, it is preferable that as the physical property value of the liquid crystal material of R (for red), the retardation Δnd is set in a range of 0.31 to 0.45, and the dielectric constant anisotropy Δ∈×the voltage V² is set in a range of −120 to −64.

When the physical property value of the liquid crystal material of each of the liquid crystal devices 100B, 100G, and 100R is set to become each relationship as illustrated in FIG. 8, the VT characteristics of each of the liquid crystal devices 100B, 100G, and 100R can be matched to each other (refer to FIG. 9). Accordingly, for example, even in a case in which the physical property value of the liquid crystal material is changed due to an increase of temperature, or the like, the difference of the amount of change in transmissivity with respect to the voltage is reduced, and thus deterioration of display quality can be suppressed.

FIG. 9 is a graph illustrating a relationship between the voltage V and the transmissivity in a case in which a dedicated liquid crystal device is used in each of colors (BGR). Hereinafter, the relationship between the voltage V and the transmissivity will be described with reference to FIG. 9.

The graph in FIG. 9 illustrates the voltage V in a horizontal axis, and the transmissivity in the vertical axis. The voltage V in a horizontal axis indicates a range of 0V to 5V. The transmissivity in the vertical axis indicates a range of 0% to 100%.

When the liquid crystal device, which includes a liquid crystal material having the physical property value as described above, is disposed as each of dedicated colors (BGR), as illustrated in FIG. 9, the VT characteristics of three colors can be matched to each other. Accordingly, an amount of change in transmissivity with respect to a voltage can be substantially matched to the voltage, even in a case in which the temperature is changed, compared to the related art, and deterioration of display quality can be suppressed. Here, it is important that declines of the VT characteristics of the three colors are substantially the same as each other. Therefore, a transmissivity change in a case of a value change where the applying voltage is included can be the same as the three colors, and deterioration of display quality can be suppressed.

As described above, according to the liquid crystal devices 100 (100B, 100G, and 100R) and the projector 1000 of the embodiment, an effect to be illustrated hereinafter can be obtained.

(1) According to the liquid crystal device 100 and the projector 1000 of the embodiment, a relationship of the physical property values (Δnd, Δ∈, gap, and Δ∈×V²) of the liquid crystal material of each of the colors (liquid crystal device 100B for blue, liquid crystal device 100G for green, and liquid crystal device 100R for red) is set in the range described above, and thus the VT characteristics of the liquid crystal material of each of the colors can be matched to each other. Accordingly, for example, even in a case in which the physical property value of the liquid crystal material is changed due to an increase of temperature, or the like, the difference of the amount of change in transmissivity with respect to the voltage is reduced, and thus deterioration of display quality can be suppressed.

Moreover, an aspect of the invention is not limited to the embodiment described above and can be appropriately modified within a scope which does not depart from the gist or spirit of the invention described in the claims and the entirety of the specification, and the modified embodiment is included in a technical range of the aspect of the invention. In addition, the invention can be realized as the following embodiments.

### Modification Example 1

As described above, the Δn is not limited to a use of liquid crystal of 0.16, and may be a liquid crystal material so that the relationships of the retardation Δnd, the dielectric constant anisotropy Δ∈, the gap, the dielectric constant anisotropy Δ∈×the voltage V², and the like are set in a numeral range, or other liquid crystal materials may be used.

### Modification Example 2

As described above, the invention is not limited to application of the liquid crystal device 100 of a transmissive type, and may be applied to a liquid crystal device of a reflective type. In this case, as the first base material 11, a silicon substrate is preferably used. In addition, the pixel electrode 27 can be formed using, for example, aluminum (Al), silver (Ag), an alloy of these metals, or a compound such as oxides, having light reflectivity. With respect to the retardation Δnd of the transmissive type liquid crystal device 100, the reflective type liquid crystal device becomes a retardation 2Δnd.

Even in this case, the relationships (2Δnd, Δ∈, gap, and Δ∈×V²) of the physical property value of the liquid crystal material of each of the colors (liquid crystal device for blue, liquid crystal device for green, and liquid crystal device for red) are set in the range described above and used, and thus the VT characteristics of a liquid crystal material of each of the colors can be matched to each other. Accordingly, for example, even in a case in which the physical property value of the liquid crystal material is changed due to an increase of temperature, or the like, the difference of the amount of change in transmissivity with respect to the voltage is reduced, and thus deterioration of display quality can be suppressed.

The entire disclosure of Japanese Patent Application No. 2015-161671, filed Aug. 19, 2015 is expressly incorporated by reference herein.

What is claimed is:

1. A liquid crystal device for a blue color comprising: a liquid crystal material that is a vertical alignment type and is disposed between a pair of substrates,
wherein a retardation Δnd of the liquid crystal material is in a range of 0.18 to 0.29, and
wherein a dielectric constant anisotropy Δ∈ of the liquid crystal material is in a range of −7.5 to −4.

2. A liquid crystal device for a green color comprising: a liquid crystal material that is a vertical alignment type and is disposed between a pair of substrates,
wherein a retardation Δnd of the liquid crystal material is in a range of 0.25 to 0.38, and
wherein a dielectric constant anisotropy Δ∈ of the liquid crystal material is in a range of −7.5 to −4.

3. A liquid crystal device for a red color comprising: a liquid crystal material that is a vertical alignment type and is disposed between a pair of substrates,
wherein a retardation Δnd of the liquid crystal material is in a range of 0.31 to 0.45,
wherein a dielectric constant anisotropy Δ∈ of the liquid crystal material is in a range of −7.5 to −4.

4. A projector comprising:
a liquid crystal device for a blue color that includes a liquid crystal material for a blue color of a vertical alignment type;
a liquid crystal device for a green color that includes a liquid crystal material for a green color of a vertical alignment type; and
a liquid crystal device for a red color that includes a liquid crystal material for a red color of a vertical alignment type,
wherein a retardation Δnd of the liquid crystal material for a blue color is in a range of 0.18 to 0.29,
wherein a retardation Δnd of the liquid crystal material for a green color is in a range of 0.25 to 0.38, and
wherein a retardation Δnd of the liquid crystal material for a red color is in a range of 0.31 to 0.45,
wherein a dielectric constant anisotropy Δ∈ each of the liquid crystal material is in a range of −7.5 to −4.

5. The projector according to claim 4,
wherein, in the liquid crystal material for a blue color, the retardation Δnd is in a range of 0.20 to 0.29, and the dielectric constant anisotropy Δ∈ is in a range of −7.5 to −4,
wherein, in the liquid crystal material for a green color, the retardation Δnd is in a range of 0.27 to 0.38, and the dielectric constant anisotropy Δ∈ is in a range of −7.5 to −4, and
wherein, in the liquid crystal material for a red color, the retardation Δnd is in a range of 0.34 to 0.45, and the dielectric constant anisotropy Δ∈ is in a range of −7.5 to −4.

6. The projector according to claim 4,
wherein a gap of the liquid crystal layer for a blue color is in a range of 1.18 to 1.80, and the dielectric constant anisotropy Δ∈ of the liquid crystal material for a blue color is in a range of −7.5 to −4,
wherein a gap of the liquid crystal layer for a green color is in a range of 1.58 to 2.40, and the dielectric constant anisotropy Δ∈ of the liquid crystal material for a green color is in a range of −7.5 to −4, and
wherein a gap of the liquid crystal layer for a red color is in a range of 1.99 to 2.80, and the dielectric constant anisotropy Δ∈ of the liquid crystal material for a red color is in a range of −7.5 to −4.

7. The projector according to claim 6,
wherein the gap of the liquid crystal layer for a blue color is in a range of 1.18 to 1.80, and the dielectric constant anisotropy Δ∈ of the liquid crystal material for a blue color is in a range of −5.5 to −4,
wherein the gap of the liquid crystal layer for a green color is in a range of 1.58 to 2.20, and the dielectric constant anisotropy Δ∈ of the liquid crystal material for a green color is in a range of −6.5 to −5, and
wherein the gap of the liquid crystal layer for a red color is in a range of 1.99 to 2.60, and the dielectric constant anisotropy Δ∈ of the liquid crystal material for a red color is in a range of −7.5 to −6.

8. The projector according to claim 4,
wherein, in the liquid crystal material for a blue color, the retardation Δnd is in a range of 0.18 to 0.29, and the dielectric constant anisotropy Δ∈× a voltage V² is in a range of −120 to −64,
wherein, in the liquid crystal material for a green color, the retardation Δnd is in a range of 0.25 to 0.38, and the dielectric constant anisotropy Δ∈× the voltage V² is in a range of −120 to −64, and
wherein, in the liquid crystal material for a red color, the retardation Δnd is in a range of 0.31 to 0.45, and the dielectric constant anisotropy Δ∈×the voltage V² is in a range of −120 to −64.

9. A liquid crystal device for a blue color comprising: a liquid crystal material disposed between a pair of substrates that is a vertical alignment type and is disposed between a pair of substrates,
wherein a retardation 2Δnd of the liquid crystal material is in a range of 0.18 to 0.29,
wherein a dielectric constant anisotropy Δ∈ of the liquid crystal material is in a range of −7.5 to −4.

10. A liquid crystal device for a green color comprising: a liquid crystal material disposed between a pair of substrates that is a vertical alignment type and is disposed between a pair of substrates,
wherein a retardation 2Δnd of the liquid crystal material is in a range of 0.25 to 0.38,
wherein a dielectric constant anisotropy Δ∈ of the liquid crystal material is in a range of −7.5 to −4.

11. A liquid crystal device for a red color comprising: a liquid crystal material disposed between a pair of substrates that is a vertical alignment type and is disposed between a pair of substrates,
wherein a retardation 2Δnd of the liquid crystal material is in a range of 0.31 to 0.45,
wherein a dielectric constant anisotropy Δ∈ of the liquid crystal material is in a range of −7.5 to −4.

12. A projector comprising:
a liquid crystal device for a blue color that includes a liquid crystal material for a blue color of a vertical alignment type;
a liquid crystal device for a green color that includes a liquid crystal material for a green color of a vertical alignment type; and
a liquid crystal device for a red color that includes a liquid crystal material for a red color of a vertical alignment type,
wherein a retardation 2Δnd of the liquid crystal material is in a range of 0.18 to 0.29,
wherein a retardation 2Δnd of the liquid crystal material is in a range of 0.25 to 0.38,
wherein a retardation 2Δnd of the liquid crystal material is in a range of 0.31 to 0.45, and
wherein a dielectric constant anisotropy Δ∈ each of the liquid crystal material is in a range of −7.5 to −4.

13. The projector according to claim 12,
wherein, in the liquid crystal material for a blue color, the retardation 2Δnd is in a range of 0.20 to 0.29,
wherein, in the liquid crystal material for a green color, the retardation 2Δnd is in a range of 0.27 to 0.38, and
wherein, in the liquid crystal material for a red color, the retardation 2Δnd is in a range of 0.34 to 0.45.

14. The projector according to claim 12,
wherein the gap of the liquid crystal layer for a blue color is in a range of 1.18 to 1.80,
wherein the gap of the liquid crystal layer for a green color is in a range of 1.58 to 2.40, and
wherein the gap of the liquid crystal layer for a red color is in a range of 1.99 to 2.80.

15. The projector according to claim 14,
wherein the gap of the liquid crystal layer for a blue color is in a range of 1.18 to 1.80, and the dielectric constant anisotropy Δ∈ of the liquid crystal material for a blue color is in a range of −5.5 to −4,
wherein the gap of the liquid crystal layer for a green color is in a range of 1.58 to 2.20, and the dielectric constant anisotropy Δ∈ of the liquid crystal material for a green color is in a range of −6.5 to −5, and
wherein the gap of the liquid crystal layer for a red color is in a range of 1.99 to 2.60, and the dielectric constant anisotropy Δ∈ of the liquid crystal material for a red color is in a range of −7.5 to −6.

16. The projector according to claim 12,
wherein, in the liquid crystal material for a blue color, the retardation 2Δnd is in a range of 0.18 to 0.29, and the dielectric constant anisotropy Δ∈×a voltage V² is in a range of −120 to −64,
wherein, in the liquid crystal material for a green color, the retardation 2Δnd is in a range of 0.25 to 0.38, and the dielectric constant anisotropy Δ∈× the voltage V² is in a range of −120 to −64, and
wherein, in the liquid crystal material for a red color, the retardation 2Δnd is in a range of 0.31 to 0.45, and the dielectric constant anisotropy Δ∈× the voltage V² is in a range of −120 to −64.
